(19) United States
(12) Patent Application Publication
(10) Pub. No.: US 2021/0142400 A1
(43) Pub. Date: May 13, 2021

(54) Method and System for Displaying Trading Volumes of a Financial Asset by Time and Price

(71) Applicant: Seven Scott Kinker, Zug (CH)

(72) Inventor: Seven Scott Kinker, Zug (CH)

(21) Appl. No.: 17/094,837

(22) Filed: Nov. 11, 2020

Related U.S. Application Data
(60) Provisional application No. 62/934,095, filed on Nov. 12, 2019.

(51) Int. Cl. G06Q 40/02; G06F 3/14; G06T 11/20; G06T 11/00

(52) U.S. Cl. CPC G06Q 40/02; G06T 11/001; G06T 11/206; G06F 3/14

(57) ABSTRACT

A computer-implemented method and system for displaying the market trading activity of a financial asset, comprising rectangular-shaped blocks drawn according to price (with respect to a vertical Y-axis), time (with respect to a horizontal X-axis) and the total traded volume at that price, during that time period (i.e. 1 minute, 10 minutes, 1 hour), wherein the color of the block is determined by the volume of the block compared to the maximum volume block on the chart. The system further comprises rectangular lines in the background color-coded to reflect the total traded volume at each price level, over multiple days, exponentially-weighted so that volume traded further back in the past is counted less. The preferred embodiment, further comprises a variety of user interface controls allowing the user to make adjustments and customize the chart displayed.

### FIELD OF INVENTION

This invention is in the field of financial trading, particularly on electronic exchanges, which broadcast trade details, particularly the time, price and volume of each trade executed.

### BACKGROUND

For decades, the trading of financial assets, such as stocks, bonds, currencies and commodities, was conducted on trading floors in financial exchanges, performed by human brokers, dealers and specialists who had exclusive access to these trading floors. During this time, the most commonly used method for observing patterns of trading activity was the ticker tape, a machine that transmitted stock trade data over telegraph wires to banks and other financial entities. Because trading was conducted by a small group of brokers and dealers, and only during a fraction of the day (about 6.5 hours), there were not too many trades reported and the ticker tape was sufficient for gaining insightful information about market trends.

As financial markets shifted to electronic trading, including the creation of Internet brokerage platforms, electronic communication networks and alternative trading systems, as well as most of the world exchanges adopting electronic matching engines, thus reducing or eliminating the need for human specialists and market-makers, there were several impacts on trading and investing.

First of all, the electronification of trading venues allowed traders and investors around the globe to buy and sell various financial assets instantly. Second, this trend has both enabled and encouraged markets to remain open for trading almost around the clock. Many exchanges are open 23 hours a day, closing only one hour for routine maintenance, software upgrades and settlement price calculations. Third, the increased automation of various procedures that were previously performed by humans, has reduced the cost of executing transactions, further increasing the number of participants. Fourth, the ease of access (often an investor requires only a simple Internet browser to enter orders), combined with the lower transaction costs, due to automation, have both led to more competitive, liquid markets, resulting in tighter bid-ask spreads (the difference between the highest prevailing order price to buy the asset and the lowest prevailing order price to sell the asset), and have caused an enormous rise in the number of shares or contracts traded every day.

The aforementioned rise in trading volumes has created the need for automated systems and methods for analyzing trading patterns in order to visualize important information and make profitable buying and selling decisions. Computer-implemented trading activity charts started to appear in the 1970s and 1980s, as the ticker tape became incapable of handling the increase in trading volumes. These first systems, such as Reuters and Bloomberg terminals were exclusively utilized by large financial institutions and wealthy investors. During the Internet boom in the 1990s, electronic trading charts became widely used by small investors and day traders, therefore leveling the playing field and leading to a surge in trading volumes.

In the 2000s and 2010s, another huge increase in trading volumes was caused by the advent and rapid expansion of both algorithmic and high-frequency trading strategies. These trading strategies utilize sophisticated tactics and technologies, including colocation of servers inside financial exchanges, usage of high-speed dedicated Internet lines for order sending, optimized computer logic, performing calculations on graphics processing units and various combinations of the aforementioned software and hardware technologies, in order to exploit tiny price discrepancies, through high volume, high speed transactions.

Traders and investors utilize trading charts, which display trading activity according to time, price and volume (number of units) traded. The patterns observed from the buying and selling activity in the market can identify price levels of support (low price) and resistance (high price), thereby presenting profitable buying and selling opportunities.

The most common price charts are line, bar and candlestick charts. Line charts are simple graphs that draw a line through all of the points plotted according to a horizontal x-axis representing time and a vertical y-axis representing the price of the asset. Bar and candlestick charts present the prices traded during a particular time period (i.e. 1 minute or 1 hour), on the same time and price axes, shaped according to the highest price, the lowest price, the opening price (first trade) and the closing price (last trade), within the given time period. Often paired with a line, bar or candlestick chart, and usually displayed underneath, is a bar chart of the volume traded during the time periods represented by the candlestick chart.

There are two sources of information missing from the candlestick chart, paired with a volume chart, that this invention will provide. First, a trader does not know what price(s) the volume presented by the bar in the volume chart was traded at. For example, although one can see that 1000 future contracts traded during a specific minute, he does not know how many contracts traded near the highest price of that minute, how many near the lowest price or in between. If most of the volume was near the low price, it could signal support and therefore a buying opportunity. If, however, most of the volume was near the highest price, it might signal resistance and therefore a selling opportunity.

Second, a trader does not know how much volume traded at specific prices earlier in the day or during previous days (yesterday, last week, last month, etc.). If heavy volume was traded at a given price, but the time periods are no longer displayed on the chart, the trader might have no awareness of said volume. Most charts have no way of displaying historical volume, especially at price levels above the highest price, or below the lowest price, on the current chart.

One way that some professional day traders have a sense of how much trading occurred at different price levels, is by watching the time and sales window and/or the market depth of the given financial asset. There are several drawbacks with these conventional approaches. First, a trader can watch only one asset at a time, so if he wishes to trade more than one asset, he would need some way of viewing such trading patterns. Second, if a trader is not watching for a specific time period (from a minute to a month, or even during the overnight session), he will not be aware of the details of the trading activity he missed. Third, there can be up to 1000 trades per second, during busy times, which often present the best buying or selling opportunities. This quantity of data requires a machine to process and display.

There are a wide range of technical indicators that traders utilize, with many of them based on complex formulas and statistics. This invention provides a vast amount of information, but keeps the math simple to comprehend. Large volume indicates that participants are willing to buy or sell a lot of shares or contracts at a specific price, often revealing levels of support and resistance. It matters more that participants are willing to buy or sell at a specific price level, than why they are making that particular trading decision. It does not matter how many participants are making trading decisions based on technical indicators, economic trends, company fundamentals, commodity supply and demand, behavioral and psychological sentiments or other approaches, as much as it matters how many are buying and how many are selling, in order to determine trends in the market price.

The order book, which displays the current buy and sell orders at several price levels above and below the current trading price, can be used to try to determine levels of support or resistance, by identifying large order sizes, but this method, while informative, can be misleading because of two market phenomenon. First of all, some orders are spoofing orders, which are placed in order to manipulate the market participants into believing it will move in that direction. Large buy orders are used to manipulate the market up, and large sell orders are used to manipulate the market down. Not intending to execute these orders, they will usually be cancelled before they trade.

A second phenomenon, that makes the order book less reliable than it appears, is the existence of reserve (also referred to as iceberg) orders. These are practically the opposite of the spoofing orders. While spoofing orders are displayed, but not intended to execute, reserve orders are not displayed, but are intended to execute. Just like an iceberg, only a small fraction of the entire order size is visible at any time in the order book.

Because there are orders that will not trade and trades that were not orders (at least not visible, before execution), the actual trading volumes are usually more practical for identifying support and resistance in the market.

### SUMMARY

Instead of simply displaying each time period as a single bar or candle, with the total volume of each time period displayed below in a separate chart, this invention draws blocks whose horizontal and vertical locations on the chart represent time periods and price levels, respectively, and whose colors represent the volumes traded at each time period and price level. In the preferred embodiment, red denotes the smallest volume traded at a given price level and time period and blue denotes the largest volume traded at a given price level and time period. A 1024 color spectrum from red to blue is utilized to color all of the blocks on the chart For example, if the highest volume traded for a given block is 1000, then a block representing 250 volume would be yellow, a 500 volume block would be green and a 750 volume block would be cyan. The helps the user to identify levels of support (heavy buying) and resistance (heavy selling), simply by viewing relatively high volume blocks on the chart.

This invention further comprises horizontal lines drawn in the background of the chart, whose locations represent price levels and whose colors represent the exponentially-weighted (decayed) volume traded at each respective price level. In the preferred embodiment, the lines are colored according to a spectrum from black, which represents no volume to white, which denotes the highest volume, of all the price levels on the chart. These lines help to illustrate where there are levels of support and resistance, by showing where heavy volume traded, either because of large orders executed at specific times at those price levels, which can indicate a big buyer or seller, or because there were many periods over time that crossed those heavy volume levels, which can signal important technical price levels. These are termed “background lines”, not only because they are drawn in the background (behind the blocks), but because they represent the background of the trading history.

In order to make the invention as useful as possible, multiple controls allow the user to adjust and customize the chart, in order to gain the most insightful, informative views of market trading activity, with respect to the trading horizon and strategy of the individual user. For example, a long-term investor might select day charts that span long time ranges and many price levels, in order to observe larger, longer trends, whereas a short-term day trader might select minute charts that zoom in on patterns of trading volume happening in real-time.

The invention further comprises providing the user the ability to alter the maximum block volume, maximum line volume, the decay rate applied to the background line volumes, and to filter out specific trade types, such as block trades, spread trades, trades executed on specific trading exchanges and platforms, or any other specific type of trade. This offers the benefit of adjusting the chart colors (both blocks and background lines) in order to best reflect the user's personal beliefs and knowledge about specific assets, trade types and exchanges. As an example, maybe a trader believes that one asset should decay it's volume at a higher rate than another asset, because he knows that many positions are not held as long. Another example might be a trader deciding that he wants to set the maximum block volume at 3000, because he thinks that is a good indicator of heavy volume, based on his historical experience with that specific asset, thus forcing the chart to draw multiple blue blocks in a given time period, if that period reflects unusually high volumes. Otherwise, the chart would draw one blue block denoting a higher volume (i.e. 5500) and blocks between 3000 and the maximum might be shades of green or cyan. In short, the system allows the user to utilize his or her knowledge and experience, in order to optimize the system, and thus the chart itself.

Similar to Google Maps, the chart is larger than the viewing window, allowing the user to scroll horizontally back and forth in time, as well as vertically up and down in price levels. In order to keep the prices and times always visible, the chart is separated into 3 sections, with the price and time sections always locked, while the user scrolls the main section horizontally and/or vertically.

Just as a picture can be worth a 1000 words, a chart can be worth 1000 numbers. This invention utilizes the human ability to discern a wide range of colors to quickly gain detailed insight about current and historical trading patterns

### Glossary

trade data: the trading data requested and received from a data source or plurality of data sources, including financial exchanges, data vendors, data files, databases or any other source of data. The details of the data consist primarily of: the asset name, the time that the trade was executed, the price at which the trade was executed and the volume (number of stock shares, futures or options contracts, or any other unit that an asset might be traded in).

historical data: the trade data from past time periods (from a minute ago, to decades ago), which is stored by exchanges and data vendors, and then used by traders for back-testing trading strategies or charting past market trends.

real-time updates: the trade data received while trading is in session, usually a real-time stream delivered by exchanges and data vendors via the Internet or private wired or wireless networks.

compressed data: historical trade data with the traded volume aggregated by the dimensions of price and time (i.e. minute or day)

preferred embodiment: whenever this is mentioned, it is for illustration purposes only. One skilled in the arts could easily envision modifications that could be made to the interface, such as moving elements to different locations, or adding, removing or changing elements, without deviating from the full scope and spirit of the invention. One skilled in the arts could also envision modifications made to the steps performed by the computer, or performing some or all of the steps in parallel and/or on a remote server.

support: a price level or plurality of price levels, below the current market price where a large amount of trading volume occurred in the past.

resistance: a price level or plurality of price levels, above the current market price where a large amount of trading volume occurred in the past.

block: a colored block, displayed on the chart, with its horizontal position determined by the time period, its vertical position determined by the price level and its color determined by the total volume of the trades that executed at that time and price, divided by the maximum block volume (which can be overridden by a user-entered value) of the current chart. There are 1024 colors used, from red (smallest volume) to blue (largest volume).

background line: a colored line in the background (behind the blocks), displayed on the chart, with its vertical position determined by the price level and its color determined by the total volume of the trades that executed at that time and price, divided by the maximum line volume (which can be overridden by a user-entered value) of the current chart. There are 256 colors used, from black (zero volume) to white (largest volume)

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 depicts the system architecture

FIG. 2 depicts the main user interface

FIG. 3 depicts an asset selection dialog window

FIG. 4-A depicts a chart with a time bar of 1 minute

FIG. 4-B depicts the chart above with a time bar of 5 minutes

FIG. 5 depicts a table of price collapse levels

FIG. 6-A depicts an ES future chart with no price levels collapsed

FIG. 6-B depicts the ES future chart above with prices collapsed 1 level

FIG. 7-A depicts an NQ future chart with no price levels collapsed

FIG. 7-B depicts the NQ future chart above with prices collapsed 1 level

FIG. 8-A depicts a chart with a block height of 8

FIG. 8-B depicts the chart above with a block height of 6

FIG. 9-A depicts a chart with a block width of 15

FIG. 9-B depicts the chart above with a block width of 7

FIG. 10-A depicts a chart with the default maximum block of 6,643

FIG. 10-B depicts the chart above with a manually entered maximum block of 1,000

FIG. 11-A depicts a chart with the background lines off

FIG. 11-B depicts the chart above with the background lines on

FIG. 11-C depicts the chart above, with the maximum background lines in view

FIG. 11-D depicts the chart above, hours later, with the background lines providing support

FIG. 12-A depicts a chart with the default maximum background line of 149,300

FIG. 12-B depicts the chart above with a manually entered maximum background line of 80,000

FIG. 13-A depicts a chart with a decay rate of 10%

FIG. 13-B depicts the chart above with a decay rate of 1%

FIG. 13-C depicts the chart above with a decay rate of 0%

FIG. 13-D depicts the chart above with a decay rate of 100%

FIG. 14-A depicts a chart with the auto-size feature off

FIG. 14-B depicts the chart above with the auto-size feature on

FIG. 15-A depicts a chart with the include close feature on

FIG. 15-B depicts the chart above with the include close feature off

FIG. 16 depicts a chart scrolled back in time, to illustrate the last traded price indicator

FIG. 17-A depicts a chart with the exclude today feature off

FIG. 17-B depicts the chart above with the exclude today feature on

FIG. 17-C depicts the chart above with the exclude today feature on, from a different time frame

FIG. 18 depicts the main steps of the method and system

FIG. 19-A depicts the steps for creating the color schemes for drawing the blocks

FIG. 19-B depicts the steps for creating the color schemes for drawing the background lines

FIG. 20 depicts the steps for loading the historical data

FIG. 21 depicts the effects of user interface parameter changes on the blocks and background lines

FIG. 22 depicts the steps for calculating the blocks

FIG. 23 depicts the steps for calculating the background lines

FIG. 24 depicts the steps for drawing the chart

### DETAILED DESCRIPTION OF THE INVENTION

### Overview of System

Referring to FIG. 1, this computer-implemented system comprises five main components:

A source or plurality of sources of financial asset trading data, including, but not limited to a direct connection to a financial trading exchange 10, access to a data vendor 20, a database, data server or data files, residing on a local computer or remote server, a blockchain or any other source of data. The most common source is a real-time data stream, from an exchange or data vendor, which could consist of colocated servers, dedicated Internet lines 30 and/or programs written to implement application programming interfaces (APIs) to receive trade updates. Other optional components could include middleware, firewalls, routers, hubs, switches, gateways and/or encryption methods. The financial assets that the data represents could include stocks, bonds, futures, options, currencies, warrants, crypto currencies, funds, swaps, indexes, STIRs (short term interest rates), ETFs (exchange traded funds), MBS (mortgage-backed securities) ABS (asset-backed securities), securitized and quantified events, synthetic or structured products and any combination of the aforementioned assets.

A computer processor 40 or plurality of processors that can execute the steps of the computer-implemented method, in the form of programmed instructions. These instructions could be coded in one or a plurality of computer languages, including, but not limited to Java, C #, C++, Python, Visual Basic or any other current or future language. The processor(s) could be embedded in a desktop computer, laptop, tablet, mobile phone, calculator, PDA, smart watch, server farm, cloud services, quantum computer or any other computing device(s).

A data storage mechanism 50 for storing compressed financial data, in order to reduce data load times and optimize the speed of loading and generating charts. Data can be stored in a plurality of sources, including, but not limited to local files, databases, historical data servers, USB drives, or external read/write devices, such as CDs, DVDs, diskettes and tape drives.

A display device 60, or plurality of display devices in order to draw the chart or plurality of charts, which could include a computer monitor, a tablet, mobile phone screen, TV, projector, movie screen, LED display, glasses with embedded displays, a virtual reality headset, contact lenses or any other device that can be used to display real-time charts. A display device could also be in the form of a static visualization, such as a printed chart or picture, such as JPEG, PNG or GIF.

A plurality of input peripherals 70, that the user can utilize in order to manipulate and customize the charts, in order to gain the most useful information about buying and selling patterns of the financial asset(s). These could include a keyboard, mouse, stylus, touch screen, trackball, laser pointer, game controller, voice-activated commands, sight-activated commands, such as blinking, or any other human-initiated or computer-implemented method for sending commands to the program.

### Detailed Description of the User Interface

Referring to FIG. 2, the main user interface is intended to be open and intuitive. In the preferred embodiment, which is for illustration purposes only, the chart is interactive and customizable, because the most informative visualization(s) depend on the individual user's investment strategy, trading tactics, risk tolerance, investment time frame and any other unique aspects and preferences of a given user.

The user interface provides numerous ways to customize the chart, with up to trillions of potential combinations of all the parameter values. Just as there are countless ways to utilize a Swiss army knife, this invention enables the user to observe countless visualizations of historical and real-time trading activity, in order to gain the most informative insights about market trends.

The main section 102 contains 4 main elements, including price lines 104 denoting the price levels of the asset, time lines 106 denoting the date and/or time of the time periods, the background lines 108 which show the volume traded at all the price levels, decayed according to the current decay rate, and the blocks 110, which show the total traded volume at each intersection of time period (e.g. 1 minute or 1 hour) and price level(s).

The price section 112 displays all the price levels, along with one of the last traded price indicators 152, described in more detail below. The time section 114 displays all the time periods. Because the chart is split into 3 sections (main, price and time), it allows the user to scroll left and right to observe different time periods, and/or to scroll up and down to observe different price levels, without losing sight of the times or the prices displayed. The price and time information is always visible, regardless of which directions the user scrolls the chart. This is similar to freezing rows and/or columns in spreadsheets.

The asset selection button 116 serves 3 purposes. It allows the user to select a financial asset to draw on the chart. It displays the current financial asset, if one has already been selected. It displays status updates, including “LOADING” when an asset is being loaded in to the chart, and “RELOAD” when the data feed has been disconnected. Referring to FIG. 3, when the user clicks the asset selection button 116, the asset selection dialog window 160 pops up, displaying various futures.

Referring to FIG. 4-A, the time bar selection drop down 118 allows the user to select the time period for the volume blocks on the chart. In the preferred embodiment, there are the following choices: 1 minute, 5 minutes, 10 minutes, 1 hour and 1 day. A large drop is shown on this 1 minute chart. Referring to FIG. 4-B, the same drop is shown on a 5 minute chart 118, where the drop does not appear quite as large. Also, in the 5 minute chart, the user can see the background line 108 with the highest volume 130.

Referring to FIG. 2, the price collapse selection drop down 120 allows the user to select the number of price levels the blocks and background lines should span. In the preferred embodiment, there are 3 choices: none, 1 level and 2 levels. If none is selected, each block and line represents 1 tick of the asset. If 1 level is selected, then each block and background line represents 4 or 10 ticks (depending on the minimum tick value). If 2 levels is selected, then each block and background line represents 16, 40 or 100 ticks (depending on the minimum tick value).

Referring to FIG. 5, the number of levels collapsed into one level is based on the tick value of the asset. The first column 200 denotes examples of futures. The second column 210 denotes the actual tick of the given future. The third column 220 denotes what the prices are collapsed into, for a collapse of 1 level, which is based on the tick value. The fourth column 230 denotes what the prices are collapsed into, for a collapse of 2 levels, which is based on the amount from 1 level collapse. For example one asset might collapse from 0.25 to 1 and another might collapse from 0.1 to 1, at 1 level, and then both of them will collapse to 10, at 2 levels.

Referring to FIG. 6-A, there is a chart with collapse set to none 120 and the user cannot simultaneously view all the blocks for the S&P 500 future, even with the lowest height 122 selected. Referring to FIG. 6-B, the price is collapsed one level 120, so the user can see all the blocks, even with a larger height 122. Referring to FIG. 7-A, there is a chart with collapse set to none 120 and the user cannot simultaneously view all the blocks for the Nasdaq 100 future, even with the lowest height 122. Referring to FIG. 7-B, the price is collapsed one level 120, allowing the user to see all the blocks, even with a higher height 122.

Referring to FIG. 8-A, the height slider 122 allows the user to alter the height of the blocks and background lines. In the preferred embodiment, the minimum is 4 pixels and the maximum is 20 pixels. By changing the height, the user can view more or fewer price levels, in order to identify levels of support and/or resistance. In this chart of the S&P 500 future, the maximum background line cannot be seen. Referring to FIG. 8-B, the height 122 is reduced to 6, which allows the user to see the support levels down below, including the background line 108 with the highest volume 130.

Referring to FIG. 9-A, the width slider 124 allows the user to alter the width of the blocks. In the preferred embodiment, the minimum is 4 pixels and the maximum is 20 pixels. By changing the width, the user can simultaneously view more periods on the chart. In this chart, the width is 15 and the chart shows almost no movement in price up or down. Referring to FIG. 9-B, the width 124 is reduced to 7, and a big drop can be seen on the left side of the chart.

Referring to FIG. 10-A, the maximum block volume edit box 126 allows the user to enter a higher or lower value for the maximum block volume, than the default, which is based on the actual maximum as calculated by the program. The default value or user-entered value might be altered according to any selected filters (more detail below). By changing this parameter, the user can alter the patterns of colors displayed by the blocks. When the maximum block is a user-entered value, the background of the edit box will be yellow. If the user deletes the value, by deleting the number or entering ‘0’, thereby reverting back to the default, the edit box background changes back to white.

Referring to FIG. 10-A, the maximum block 126 is calculated automatically (the default), with a current value of 6,643, which causes the volume traded in the overnight session to appear all red. Referring to FIG. 10-B, a value of 1000 is entered in the maximum block edit box 126, and the day session becomes mostly blue, but the user can now see volume patterns in the overnight sessions.

Referring to FIG. 11-A, the background check box 128 allows the user to turn the background lines (historical volume traded) on and off. In the preferred embodiment, if background is off, the chart will only display the prices that have traded during the time frame displayed. If the background is on, the chart will display several levels above the high price and several levels below the low price for the current time frame displayed. The advantage is that the user can observe potential levels of support below, or resistance above, beyond what has been traded during the time frame displayed on the chart.

Referring to FIG. 11-A, the background checkbox 128 is not selected, and the background of the chart is just like a standard trading chart. Referring to FIG. 11-B, the background check box 128 is selected and the background now displays the volume traded at all the price levels, decayed according to the decay rate value of 10% cumulative per trade date. Referring to FIG. 11-C, with the background check box 128 selected, the value of this feature is shown, because the user can observe background lines with high volume 108 down below where the asset is currently trading, including the highest volume background line 130. Referring to FIG. 11-D, which is a couple hours later, with the background check box 128 selected, the high volume levels 108 successfully hold up as support for the asset price.

Referring to FIG. 12-A, the maximum line volume edit box 130 allows the user to enter a higher or lower value for the maximum background line volume, than the default, which is based on the actual maximum as calculated by the program. The default value or user-entered value might be altered according to any selected filters or an optional decay rate. By changing this parameter, the user can alter the patterns of colors displayed by the background lines. When the maximum background line is a user-entered value, the background of the edit box will be yellow. If the user deletes the value, by deleting the number or entering ‘0’, thereby reverting back to the default, the edit box background changes back to white.

Referring to FIG. 12-A, the maximum line 130 volume is automatically calculated by the program (the default), with the value of 149,300, causing the nearby price levels 108 to all appear gray. Referring to FIG. 12-B, a value of 80,000 is manually entered for the maximum line 130, allowing the user to see a clearer picture of the volumes traded at the visible price levels 108.

Referring to FIG. 13-A, the decay rate edit box 132 allows the user to alter the rate of decay of historical volumes. In the preferred embodiment, the valid values are a range of integers from 0 (no decay) to 100 (complete decay). If the value is 0, each price level will display the total volume traded at that price over the entire time period. If the value is 100, then only volume that traded during the current trading day/session will be displayed. If the value is any number from 1 to 99, then the volume traded today will be counted 100%, the volume traded yesterday will be reduced by a percentage denoted by the value (e.g. 10%), with the decay rate compounding with each trading day. For example, if the rate is set at 10%, a 1000 shares or contracts traded yesterday will count as 900, 1000 traded 2 days ago will count as 810 (90% of 90% of 1000) and so on. The purpose of this parameter is to account for the fact that heavy volume traded farther back in time will very likely not have as much of an impact as heavy volume traded more recently. The user can change this parameter in order to gain different perspectives about historical trading patterns.

Referring to FIG. 13-A, the decay rate 132 is set at 10% and the maximum background line 130 is shown on the chart as 323, 908 volume at the price 2880 108. Referring to FIG. 13-B, the decay rate 132 is reduced to 1%, giving more weight to the volume traded in the past, relative to the volume traded recently. While the volume of the same 2880 line 108 is higher, at 363,986, it is no longer the maximum line 130, since that is now 735,097. Referring to FIG. 13-C, by setting 0 decay rate 132, the 2880 line 108 is higher still, at 368,855, but is now even darker, because it is even lower, relative to the new maximum line 130 value of 1,913,661. Referring to FIG. 13-D, the decay rate 132 is set to 100, which will completely discount all volume traded before the current trade date, so the chart is black above the highest price level traded today and below the lowest price traded today. The 2880 price level 108 is now only 141,323 since it only counts the volume traded today, and it is the maximum background line 130.

Referring to FIG. 14-A, the auto-size check box 134 allows the user to toggle between choosing to customize the sizes of blocks, using the width and height sliders, or letting the computer automatically size the chart to fit into the current window.

Referring to FIG. 14-A, an hourly chart is shown, with auto-size check box 134 not selected. The user can only view about 50 points of price levels and about 4 days. Referring to FIG. 14-B, with the auto-size check box 134 selected, the user can see a more complete picture, including 20 more points to the upside and 6 more days.

Referring to FIG. 15-A, the include close check box 136 allows the user to decide whether or not to include the volumes traded near the market close for determining the colors. Because of high volume that occurs near the close of the main session of the futures markets, extremely large trading volumes can distort the chart, thus making it more difficult to identify trading patterns. Other filters that could be applied would be allowing the user to determine whether or not to exclude block trades, spread trades, or even trades that execute on specific exchanges. If include close is off, blocks near the market close (within 10 minutes in the preferred embodiment) that have a higher volume than the highest block, which is not near the market close, will be blue (the maximum volume color), but will still display the actual volume traded in the tooltip.

Referring to FIG. 15-A, the include close check box 136 is selected and because 46,457 contracts traded within a 5 minute period (maximum block 126), at the price 2919, shown by block 110, it distorts the color scale and causes most of the chart to be colored red. Referring to FIG. 15-B, by not selecting the include close box 136, the volume traded close to the market close price is not counted toward the maximum volume, so the maximum block value 126 is only 8,897. Even though the volume near the close is not counted toward the maximum block, the actual traded volume is displayed in the tooltip of highest volume block 110.

Referring to FIG. 16, the lock right check box 138 allows the user to force the chart to always be displaying the most recent time period. By deselecting lock right, the user can scroll back in time to see past trading patterns. Referring to FIG. 16, the user is scrolling back in time to observe past trading patterns. While the user is viewing time periods between 3:50 and 5:40 PM, shown in the time section 114, at the current time of 8:28 PM, shown in the time box 142, he can see that the market is currently trading down at 2933, by the last indicator 152 in the price section.

Referring to FIG. 2, the date text box 140 displays the current trade date. The time text box 142 displays the current time in seconds.

Referring to FIG. 2, the reset button 144 allows the user to force the program to redraw the entire chart. This is useful when a race condition, while handling the price updates, causes a portion of the chart to be missing. Although this issue is rare, and the program would automatically redraw the entire chart at the start of the next minute or the next user interface change, it was deemed useful to grant the user the ability to “fix” the chart quickly.

Referring to FIG. 2, the help button 146 opens the website, where the user can find about the features and functions that can be used to customize the chart, how they work, what the allowable values are and other instructive information for the user.

Referring to FIG. 2, the tooltip 148 is displayed when the user hovers the mouse or other pointing device over a specific block or background line. Details about the volume traded, including the price and/or time, are displayed for the user.

Referring to FIG. 2, there are 2 last traded price indicators. The first indicator 150 is a white border drawn around the block that is in the most recent time period and encompasses the last price that the asset traded at. The second indicator 152 is a red (if the last price is lower than the previous price the asset traded at) or green (if the last price is higher than the previous price the asset traded at) border around the last price level(s) on the price section of the chart. The second last traded price indicator allows the user to see what price the asset is currently trading at, even when the user is scrolling back to observe past time periods (unless the last traded price is out of the current price range of the chart window).

Referring to FIG. 2, the auto-collapse check box 154 allows the program to automatically collapse or expand price levels, based on the number of price levels represented by the blocks. This is especially useful when switching between different time periods, such as 1 minute and 1 day, in which the number of price levels can go up and down significant amounts.

Referring to FIG. 17-A, the exclude today check box 156 allows the user to decide whether or not to include the volume traded today, in the background lines. By excluding trades executed during the current trade date, the user avoids what could be self-fulfilling patterns. For example, unless a trader was watching the chart closely the entire day, he could wonder whether the market bounced off a high volume (white) line, or created it. On the other hand, by including today's volume in the background lines, the user can see price levels increasing or decreasing in significance real-time.

Referring to FIG. 17-A, the exclude today check box 156, the ES future is trading at all time highs, and we see a band of high volume from the background lines 108 where the market has been trading. Referring to FIG. 17-B, with the exclude today 156 enabled, which allows the user to not count the volume traded today in the background lines 108, we see no band of volume displayed. If the future was not at all-time highs, the background would simply darken in color. Referring to FIG. 17-C, with exclude today 156 enabled, there is a more encompassing view, in which we see no background lines 108 for the current trading day.

### Summary of Steps

Referring to FIG. 18, this computer-implemented system comprises the following main steps:

1. Create the user interface 300

2. Define the color schemes for drawing the volume blocks and background lines 310

3. Selection of the financial asset 320

4. Load Historical Data 330

5. Start a loop 340 to repeatedly perform the following steps:
a. Receive, compress and store real-time trade updates 350
b. Handle User Interface changes to chart parameters 360
c. Calculate Block volumes 370
d. Calculate background line volumes 380
e. Draw the chart 390

### Detailed Description of the Steps

The program first creates the user interface. In the preferred embodiment, the interface is open, like a dashboard, enabling the user to make quick changes and customize the chart in order gain the most insightful information about market patterns. The features included in FIG. 2, which is described in detail in the section above, could be rearranged, or controls could be added or omitted without deviating from the full spirit and scope of the invention.

Referring to FIG. 19-A, the next step is creating the color schemes for the blocks and background lines. The program creates 1024 colors for the blocks 400, that span from red (lowest volume) to blue (highest volume), by calculating an RGB vector for each of the colors. If the index number is less than 256, the color ranges from red to yellow 410. If the index is between 256 and 511, the color ranges from yellow to green 420. If the index is between 512 and 767, the color ranges from green to cyan 430. If the index is greater than 767, the color ranges from cyan to blue 440. Referring to FIG. 19-B, 256 colors for the background lines are created 460, that span from black (zero volume) to white (highest volume) 470, by calculating an RGB vector for each of the colors.

At this point, the program is ready for user input, which will usually be to click the asset selection button, which launches an asset selection dialog window. Once the user selects an asset and clicks OK, the program searches for historical compressed data.

Referring to FIG. 20, if compressed data is available, the program loads the compressed data 500. After the historical compressed data is loaded, the program requests any historical trade data from the data source 510, spanning the trade date and time immediately after the most recent trade date and time in the compressed data, up to now. Once received, this data is compressed 520 and stored 530, so the compression of trade data is only necessary once for each asset loaded. If the means are available, for a given asset and data source, an alternate embodiment that would optimize historical data loading, would be to send the compressed data sets, rather than all the individual trades.

While reading compressed data, as well as requested historical data from a data source, a crucial operation is to detect any gaps in the data 540. In the preferred embodiment, the program scans for any hours or days that have no volume. It is common for an asset to not trade for smaller time periods, such as seconds or minutes, but it is rare for an asset to not trade for an entire hour.

There might be valid reasons for some gaps in the data, such as an exchange halt imposed on a stock, a technical problem at an exchange or a rare quiet period. If there is a valid reason for a gap in data, then there is no problem. However, if a gap is due to errors in reading data (files are corrupted or missing), or requesting and receiving data (problems with the Internet, the computer or any other machine that is utilized for handling data), then the missing data will distort the chart and cause it to be uninformative or misleading. As an example of the potential severity, even if the missing periods are a few days from last week, and not displayed on the chart, the background lines will display an incorrect pattern of historical volumes at the affected price levels.

The next step is to initiate a loop that will repeatedly perform the following: receiving, compressing and storing (in one or more collections) the real-time trade updates, handling user interface changes to parameters, calculating the block and background line volumes and drawing the chart.

In the preferred embodiment, trade data (both loaded compressed data and received trade updates) is stored in 6 different data collections, including:

1. All minutes: volume by price and minute for yesterday and today
2. Recent minutes: volume by price and minute for the past few minutes
3. All hours: volume by price and hour for the last 2 weeks up to yesterday
4. Recent hours: volume by price and hour for today
5. All days: volume by price and day for 100+ days up to yesterday
6. Today: volume by price for today

The reason the preferred embodiment utilizes multiple collections, is a trade-off between simplicity and speed. While the program must aggregate (compress) data by price and time, the minimum requirement is at least one collection with the minimum granularity (i.e. minute by tick). Rather than scan over 1000 minutes per day, in order to calculate and draw day charts, smaller collections with less granularity are utilized.

The reason for the recent collections is also trading simplicity for speed. Instead of constantly drawing the entire chart, which could slow the performance and/or strain the CPU, the system only redraws the entire chart every minute, or when there is a significant change (i.e. new high price or change in block height), as detailed below. Most of the time, it only redraws the most recent blocks, so it makes use of smaller collections.

While there are many ways to store data in a computer program, including, but not limited to arrays, dictionaries, hash tables and lists, the preferred embodiment makes use of two specific collections. Because the program needs to be able to sort the historical day volumes (up to yesterday), in order to calculate the correct compounded decay rate for each trade date, a sorted dictionary is utilized for this collection.

The other collections do not need to be sorted, but they do need to be able to be accessed by the price feed and the drawing of the chart simultaneously, therefore concurrent dictionaries are used for all the other collections. Without using a concurrent dictionary, either the price updates or the chart drawing could be delayed, in order to wait for the other process to finish accessing the collection.

Referring to FIG. 21, the effects of user interface parameter changes are shown. Some effect the drawing of the blocks, some effect the background lines and some effect both. The first column 600, denotes the user interface parameter name. The second column 610 denotes the item number, as shown in FIG. 2. The third column 620 denotes whether a change in the given parameter will affect how the blocks are calculated or drawn. The fourth column 630 denotes whether or not a change in the given parameter affects how the background lines are calculated or drawn.

Referring to FIG. 22, the calculation of the block volumes is shown. The first step is to select the data collection to iterate 700, if there is more than one, based on the time period chosen, such as 5 minute or 1 day. As the data in the collection is aggregated further by time, and by price collapse selection 710, there are 5 variables that are tracked, including the maximum block amount 720, the highest price traded 730, the lowest price traded 740, the earliest time period 750 and the latest time period 760.

The invention offers the user several choices for determining the maximum block value, which determines the color pattern of all the blocks.
1. The default is to simply allow the program to calculate the maximum block volume as traded in the market.
2. The user can enter a specific value.
3. The user can define a formula, based on historical statistics, such as the average block volume plus 2 standard deviations of the historical block volumes.
4. Along with one of the above choices, the user can choose to exclude some trades from being counted toward the maximum block value, such as block trades (large-sized orders arranged and executed away from the exchange), spread trades (involving the simultaneous buying of one asset or expiration and the selling of another asset or expiration), trades near the market close, trades on specific exchanges or any other type of trade.

Referring to FIG. 23, the steps for calculating the background lines is shown. The rate for decaying the volume is initially set to the user-selected decay rate 800. The collection containing the daily volumes by price is sorted in reverse, so the most recent days are the first to be read 810. If exclude today is checked, the volume traded today is excluded 820. If today's volume is included, it is counted 100%. Only past days are decayed. Every time there is a new date 830, the rate is multiplied by the decay rate again 840, so that older traded volume is counted less than more recently traded volume.

Referring to FIG. 23, as the data collection is iterated, the total decayed volume is aggregated by price level 850. Three variables are tracked as the data is iterated: the maximum background line volume 860, the highest traded price 870 and the lowest traded price 880.

Along with the initial loading of the asset, the historical daily data (traded before today) is only recalculated whenever the user changes the decay rate of the chart, or when a new high or low price occurs, as this will affect the number of background price levels displayed on the chart. Only the volume traded today needs to be recalculated repeatedly.

There are 3 useful options for the calculations of block and background line volumes. First, the user should be able to set a cutoff date, so that any trading volume that occurred before that date is not counted. One example could be a future expiration or rollover date. To illustrate, if the current front-month future is the June expiration, a user could choose not to include any volume traded before the date when the June future became the most traded contract. Another could be a user-specified time frame, such as one year or an arbitrarily chosen date.

Second, the program should offer the user the choice of adjusting historical volumes and prices to account for, and accurately reflect, stock splits, futures expiration month fair values and any other adjustments made to an asset over time.

Third, the program should allow the user to decide whether or not to include the volume traded today, in the background lines. By excluding trades executed during the current trade date, the user avoids what could be self-fulfilling patterns. For example, unless a trader was watching the chart closely the entire day, he could wonder whether the market bounced off a high volume (white) line, or created it. On the other hand, by including today's volume in the background lines, the user can see price levels increasing or decreasing in significance real-time.

Referring to FIG. 24, are the steps for drawing the chart. In the preferred embodiment, there are two methods for drawing the chart. The most recent block volumes are recalculated and redrawn every second, while the entire chart is redrawn whenever one of the following events occurs:
A new minute occurs 900. Even if a new minute would not create a new 5 minute, 10 minute, or hourly time period, the entire chart is still updated in order to update the background lines.
When a new maximum block volume occurs 910, as this will affect the color pattern, unless the maximum block is explicitly set by the user.
When a new high or low traded price occurs 920, since these will affect the size of the chart.
When the user changes any of the parameters of the chart 930, such as the block width or the decay rate for the background lines.

Referring to FIG. 24, if the entire chart is to be drawn, the following steps are performed:
1. Calculate the sizes of the three sections: main, price and time 940
2. Draw the background lines in the main section 950
3. Draw time lines in the main section 960
4. Draw times and dates in the time section 965
5. Draw price lines in the main section 970
6. Draw price levels in the price section 975
7. Draw the blocks in the main section 980
8. Draw the last traded price indicators, with one in the main section and one in the price section 990

Referring to FIG. 24, if the system is only supposed to update the blocks in the most recent time period(s), the following steps are performed:
1. Draw the recently changed blocks 985
2. Draw the last traded price indicators, with one in the main section and one in the price section 990

Referring to FIG. 2, the total height of both the main section 102 and the price section 112 are based on the number of price levels multiplied by the user-selected block height 122. The number of price levels is dependent on two main factors: 1) the current price collapse selection 120 and 2) whether the background lines 128 are displayed or not. If background lines are displayed, then several price levels above the high block price and below the low block price are shown on the chart, to identify nearby levels of support and resistance.

Referring to FIG. 2, the total width of both the main section 102 and the time section 114 are based on the number of time periods multiplied by the user-selected block width 124.

Referring to FIG. 2, each of the background lines 108 are drawn in the main section 102, according to two main variables. The vertical location (Y axis) is determined by the price level of the background line, with respect to the maximum and minimum price levels on the chart. The color is determined by the total traded volume (decayed over time according to the decay rate 132) at that price level, with respect to the maximum (decayed) background line volume 130 on the chart.

Referring to FIG. 2, price lines 104 are drawn in the main section 102, aligned with the respective price levels displayed in the price section 112. Time lines 106 are drawn in the main section 102 aligned with the respective times/days displayed in the time section 114. Double-locked scroll bars on both the bottom (times) and right (prices) sides of the chart keep the sections aligned, regardless of which directions the user scrolls the chart.

Referring to FIG. 2, each of the blocks 110 are drawn in the main section 102, according to three main variables. The vertical location (Y axis) is determined by the price level of the block, with respect to the maximum and minimum price levels on the chart. The horizontal location (X axis) is determined by the time and/or day represented by the block, with respect to the earliest and latest time periods on the chart. The color is determined by the total traded volume at that intersection of price level and time period, with respect to the maximum block volume 126 on the chart.

Referring to FIG. 2, two last traded price indicators are displayed on the chart. First, the block that is in the most current time period and contains the last traded price, has a white border 150 drawn around it. Second, in the price section, a border around the last traded price level 152 is drawn. This second indicator has two additional benefits: 1) the border is colored red if the last traded price is lower than the previous traded price or green in the last traded price is higher than the previous traded price, showing the last tick trend. 2) this indicator is often visible, even when the user is scrolling back in time to view past time trading patterns.

Similar to Google Maps, the chart is larger than the viewing window, allowing the user to scroll horizontally back and forth in time, as well as vertically up and down in price levels. In order to keep both the prices and times always visible, the chart is separated into 3 sections, with the price and time sections always locked in place (frozen), while the user scrolls the main section horizontally and/or vertically. This is accomplished by creating 2 vertical scroll bars and 2 horizontal scroll bars. Only the scroll bars for the price section and time section are visible to the user. As the user horizontally scrolls the time section, the horizontal scroll bar on the main section, which is hidden to the user, automatically scrolls the same amount and direction. As the user vertically scrolls the price section, the vertical scroll bar on the main section, which is hidden to the user, automatically scrolls the same amount and direction.

A machine is necessary for a plurality of functions that would be impossible to mentally process accurately, including:
1. Handling the price updates, which can be very high in velocity (more than 1000 per second), and volume (more than a million per day).
2. Compressing individual trade data into total volumes traded at prices and times, which reduces data for the blocks approximately 1000:1 and the data for the background lines approximately 10,000:1
3. Calculating the total amount of volume traded at every intersection of time unit and price level(s), in order to create thousands of blocks.
4. Calculating the total amount of volume traded at every price level or group of price levels, wherein the volume on each trade date is decayed an increasing amount going back in time, in order to create hundreds of background lines.
5. Calculating the correct colors, from a range of 1024 defined colors, to correspond to the sums of trading volumes, calculated for all of the volume blocks.
6. Calculating the correct colors, from a range of 256 black and white shades, to correspond to the decayed sums of trading volumes, calculated for all the background lines.
7. Updating the recently changed volume blocks on the chart every second, as price updates are received
8. Updating the entire chart, including all volume blocks, background lines, time lines and price lines, during the following situations:
   a. Every minute
   b. New maximum block volume
   c. New high price
   d. New low price
   e. When the user changes any of the parameters of the chart, such as the block width or the decay rate for historical background lines
9. Handling user interface input commands, for changing and customizing the charts

### ALTERNATE EMBODIMENTS

Making the blocks larger or smaller, based on the volume of the block. This was not chosen for the preferred embodiment, because blocks could cover other blocks, or be too small to easily observe.

Making the blocks stick out in a 3D visual. This was not chosen, because some blocks could tower over others, making shorter blocks difficult or impossible to observe.

Drawing the background lines a different shade for each trade day (or other time period), based on the volume at that point. This was not chosen, in order to keep the meaning and the chart simpler, opting instead to utilize decay rates to manipulate historical trading volumes.

Using different maximum block values for different trading sessions, to account for the difference in volumes throughout the day. This can be misleading, so the user has the alternative option of entering a specific value, as depicted in FIG. 10-B.

Shaping the columns of blocks like candlesticks, wherein the blocks between the open (first trade) and close (last trade) of the time period are thicker in width and the rest of the blocks are thinner in width. Because candlestick charts are prevalent in other applications, and making some blocks narrower than others can decrease the information provided, this was not included in the preferred embodiment. The colors, more than sizes, provide most of the information.

Decaying the historical volume values in an exponential method, thereby making the more recent volumes count significantly more than volumes traded farther back in time.

Drawing a border, or some other visual indicator, around the blocks to reflect how much of the volume of that block traded at the bid price (denoting selling pressure) and how much traded at the ask price (denoting buying pressure), perhaps a color shade between red (to reflect selling) and green (to reflect buying). This requires extra information about whether the trade was a “buy” (traded on ask price) or a “sell” (traded at the bid price), which not all exchanges or data providers provide, or it requires tracking a significant amount of additional information (all bid and ask orders) in order to try to establish whether each trade was a buy or sell. This can reduce the speed of the program.

Displaying the current buy and sell orders (known as level 2 or the market depth) on the right side of the chart. This feature would significantly increase the amount of data, potentially over-complicating the program or slowing down its performance to update the chart. Also, this information is prevalent in other applications and trading interfaces.

Allowing the user to select a plurality of assets or plurality of expirations of a future. The prices of the different assets would need to normalized or offset to standardize their display on the chart.

1. A computer-implemented method and system for displaying financial trading activity, by time, price and volume, comprising the following steps:
1. Selecting one or a plurality of financial assets
2. Gathering tick data for said financial assets, from a database, a price vendor, an exchange or any other data source(s).
3. Storing said tick data into collections, by calculating the cumulative traded volume, by the dimensions of time and price
4. Computing a range of colors to represent the plurality of volumes, represented by the members of said collection.
5. Displaying the information on a chart, by drawing blocks, with each block representing a traded volume at a specific time and price, as stored in said data collections

2. The computer-implemented method and system of claim 1, further comprising the ability to select a group of blocks and have the total volume traded of all the blocks in the group displayed

3. The computer-implemented method and system of claim 1, further comprising the ability to manually set the maximum block volume, in order to prevent outliers from distorting the chart

4. The computer-implemented method and system of claim 1, wherein the blocks are shaped like candlestick bars, in order to display the open, high, low and close of the time period, with the blocks between the open and close (inclusive) wider than the other blocks of that same time period.

5. The computer-implemented method and system of claim 1, wherein the maximum block value is automatically calculated based on a formula, using the average block volume, the standard deviation of the block volumes, or any other statistical measurements of block volumes over specific historical time periods

6. The computer-implemented method and system of claim 1, further comprising the choice of collapsing (consolidating) price levels for the collections

7. The computer-implemented method and system of claim 1, wherein the historical traded volume is adjusted to account for past stock splits, future expiration fair values, or other adjustments made to financial asset prices

8. The computer-implemented method and system of claim 1, further comprising the ability to filter out (exclude) specific types of trades or periods of trading activity, with the intention of preventing distorted charts, due to outliers of time, price or volume, including, but not limited to spread trades, block trades, trades near the market close time, trades from a specific exchange, or any other identifiable type of trade.

9. The computer-implemented method and system of claim 10, wherein the selection is not a single asset and expiration, but a plurality of related assets and/or a plurality of contract expirations, wherein each asset is normalized to an anchor asset, which serves as a benchmark index, and each expiration is offset to account for the difference in fair value, usually defined as the risk-free interest rate minus the dividend/income yield over the time period from the trade date to the expiration date of the respective contract

10. The computer-implemented method and system of claim 1, wherein the blocks are drawn with different sizes to represent the quantities of volume traded at respective times and prices

11. The computer-implemented method and system of claim 1, wherein the blocks are drawn with a third dimension representing the quantities of volume traded at respective times and prices

12. A computer-implemented method and system for displaying historical financial trading activity, by price and volume, which can be combined with the blocks of claim 1, or a conventional line, bar or candlestick chart, comprising the following steps:
1. Selecting one or a plurality of financial assets
2. Gathering tick data for said financial assets, from a database, a price vendor, an financial exchange or any other data source(s).
3. Storing said tick data into collections, by calculating the cumulative traded volume, by the dimension of price, with the volume being increasingly reduced as trades occur further back in time
4. Computing a range of colors to represent the plurality of volumes, represented by the members of said collection.
5. Displaying the information on a chart, by drawing lines in the background, with each line representing a traded volume at a specific price, as stored in said data collections

13. The computer-implemented method and system of claim 12, further comprising the ability to manually set the maximum line volume, in order to prevent outliers from distorting the chart

14. The computer-implemented method and system of claim 12, further comprising the ability to set a decay rate, which is used to reduce the volume traded in the past

15. The computer-implemented method and system of claim 12, wherein the historical traded volume contains cutoff dates, such as a user-selected date or expiration date, beyond which volume is not counted.

16. The computer-implemented method and system of claim 12, wherein the historical traded volume is adjusted to account for past stock splits, future expiration fair values, or other adjustments made to financial asset prices

17. The computer-implemented method and system of claim 12, further comprising the choice of collapsing (consolidating) price levels for the collections

18. The computer-implemented method and system of claim 12, wherein the selection is not a single asset and expiration, but a plurality of related assets and/or a plurality of contract expirations, wherein each asset is normalized to an anchor asset, which serves as a benchmark index, and each expiration is offset to account for the difference in fair value, usually defined as the risk-free interest rate minus the dividend/income yield over the time period from the trade date to the expiration date of the respective contract

19. The computer-implemented method and system of claim 12, further comprising logic to compress trade data into collections to optimize the speed of reading historical data and/or reloading different assets.

20. The computer-implemented method and system of claim 12, further comprising the ability to filter out (exclude) specific types of trades or periods of trading activity, with the intention of preventing distorted charts, due to outliers of time, price or volume, including, but not limited to spread trades, block trades, trades near the market close time, trades from a specific exchange, or any other identifiable type of trade.
